(19) United States
(12) Patent Application Publication
(10) Pub. No.: US 2009/0003141 A1
(43) Pub. Date: Jan. 1, 2009

(54) Timepiece

(75) Inventor: Noriaki Ozawa, Nagano-ken (JP)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(73) Assignee: SEIKO EPSON CORPORATION, Tokyo (JP)

(21) Appl. No.: 12/127,693

(22) Filed: May 27, 2008

(30) Foreign Application Priority Data
Jun. 27, 2007 (JP) 2007-169221
Jun. 27, 2007 (JP) 2007-169223

(51) Int. Cl. G04B 37/00

(52) U.S. Cl. 368/294

(57) ABSTRACT

A timepiece having a retainer ring including a timepiece crystal and a glass retaining unit that holds the outside edge of the crystal, a back cover that is disposed facing the retainer ring, a case member that is substantially annular, is made at least in part from a non-magnetic member, and links the outside edges of the retainer ring and the back cover, an antenna that is disposed in a space formed between the retainer ring and the back cover, and can receive radio signals that pass through the non-magnetic member of the case member to the inside of the case member, and a timekeeping unit that is disposed in a space formed between the retainer ring and the back cover, and has a time display unit for displaying the time.

### CROSS-REFERENCE TO RELATED APPLICATIONS

Japanese Patent applications No.(s) 2007-169221 and 2007-169223 are hereby incorporated by reference in their entirety.

### FIELD OF INVENTION

The present invention relates to a timepiece with a built-in antenna.

### DESCRIPTION OF RELATED ART

Japanese Unexamined Patent Appl. Pub. JP-A-2006-275580 and Japanese Unexamined Patent Appl. Pub. JP-A-02-116784 teach so-called radio-controlled timepieces that set the time based on time information contained in a received standard time signal.

The radio-controlled timepiece taught in Japanese Unexamined Patent Appl. Pub. JP-A-2006-275580 has a timepiece case that is a substantially annular metal member, a crystal that is attached with an intervening packing member to the top of the timepiece case, a back cover that is made of metal and attached to the bottom of the timepiece case, and a movement including a radio-controlled timepiece receiver that is disposed inside the timepiece case. A hollow is rendered in the inside surface and back cover of the timepiece case in this radio-controlled timepiece, and an arrangement of engaged non-magnetic members with electrical resistivity of 7.00 μΩ or less is disposed in this hollow.

Japanese Unexamined Patent Appl. Pub. JP-A-02-116784 teaches a skeleton timepiece that renders a housing area in an annular case, and attaches a face crystal and a back cover to the sealed portions of the case.

Disposing non-magnetic parts in a part of the radio-controlled timepiece renders an arrangement that reduces disruption of resonance near the receiver part of the radio-controlled timepiece, but sufficient reception sensitivity cannot be achieved because the timepiece case and back cover are metal. A problem with the skeleton timepiece such as taught in Japanese Unexamined Patent Appl. Pub. JP-A-02-116784 is that when the case is made of glass and a hole for inserting the crown is formed in the case, the hole greatly reduces the durability of the case.

### SUMMARY OF INVENTION

A timepiece according to the present invention achieves both good reception sensitivity and durability.

A first aspect of the invention is a timepiece having: a retainer ring including a timepiece crystal and a glass retaining unit that holds the outside edge of the crystal; a back cover that is disposed facing the retainer ring; a case member that is substantially annular, is made at least in part from a non-magnetic member, and links the outside edges of the retainer ring and the back cover; an antenna that is disposed in a space formed between the retainer ring and the back cover, and can receive radio signals that pass through the non-magnetic member of the case member to the inside of the case member; and a timekeeping unit that is disposed in a space formed between the retainer ring and the back cover, and has a time display unit for displaying the time.

At least part of the case member that connects the outside edges of the retainer ring and back cover is formed by a non-magnetic member in a timepiece according to this aspect of the invention. An antenna that can receive predetermined radio signals (external wireless information) is disposed in the space between the retainer ring and the back cover, or more particularly inside the case rendered by the retainer ring, the back cover, and the case member.

By thus rendering at least part of the case member from a non-magnetic material, radio frequency signals can pass through the non-magnetic part of the side of the timepiece, can be received by the antenna with good signal strength, and reception sensitivity can thus be improved.

Furthermore, because a non-magnetic member is included in the case member and RF signals can therefore pass into the case through the side of the timepiece, the reception sensitivity of the antenna can be improved compared with a wristwatch that has a back cover made of glass or other non-magnetic member and a metal case member. More specifically, when GPS signals, for example, are the received radio frequency signals in a timepiece that has a back cover made of glass or other non-magnetic material, the GPS signal reception sensitivity is reduced when the back cover is in contact with the skin when the wristwatch is worn on the wrist. The reception sensitivity of the antenna also drops when the wristwatch band is metal and the wristwatch is removed from the wrist and placed with the metal band near the back cover. However, by rendering a non-magnetic member in at least part of the case member, external wireless information such as carried by GPS signals can be received with good signal strength even when the wristwatch is worn on the wrist because the non-magnetic case member does not contact the wrist. Furthermore, even if a metal band is used as the wristwatch band, the metal band will not contact the case member when the wristwatch is removed from the wrist, and good reception sensitivity can be maintained. The reception sensitivity of the antenna is therefore better than when the back cover is made from a non-magnetic member.

Examples of the radio frequency signals received by the antenna include standard time signals carrying time information, GPS signals, and cell phone signals, and the correct time can be displayed by adjusting the time displayed on the time display unit (the movement of an analog timepiece or the timekeeping module of a digital timepiece) of the timekeeping unit (the hands and dial of an analog timepiece, or the liquid crystal display or organic electroluminescent display of a digital timepiece) based on the time information decoded from the received signal.

Furthermore, because the RF signals can pass into the case from the side of the timepiece case (case member), signals can be received by the antenna even if the dial or back cover is metal. A metal dial, which is conventionally difficult to use in a radio-controlled timepiece, can therefore be used in a radio-controlled timepiece, and the design of the dial can be improved.

Preferably, the non-magnetic member of the case member is formed in a ring around the circumference of the case member.

The non-magnetic member in this aspect of the invention is formed in a ring around the circumference of the case member. Compared with an arrangement in which the non-magnetic member is formed in a C-shape circumferentially to the case member, rendering the non-magnetic member as a closed ring improves the radial durability and strength and provides greater protection against damage caused by impact.

Furthermore, because the non-magnetic member is disposed around the full circumference on the side of the timepiece, radio signals can pass through the non-magnetic member from any direction, and the reception sensitivity of the antenna can be improved.

Further preferably, the case member is made from glass, which is a non-magnetic member.

By making the case member from glass, a timepiece with an outstanding design, including being able to see inside the timepiece through the case member, can be provided.

Yet further preferably, the back cover includes a flat non-magnetic member, and a retainer part that holds the outside edge of the non-magnetic member.

By thus rendering the back cover with glass or other non-magnetic member, the antenna can be disposed near the back cover with the part of the back cover near the antenna being a non-magnetic member so that there are no metal or other magnetic parts near the antenna. This improves the reception sensitivity of the antenna compared with an arrangement in which the entire back cover is metal.

Yet further preferably, the time display unit of the timekeeping unit has hands and a dial; and the dial is a non-magnetic member.

Because the dial is a non-magnetic member in this aspect of the invention, the dial does not interfere with signal reception even when the antenna is located near the dial, and reception sensitivity is thus improved compared with an arrangement using a metal dial.

In another preferred aspect of the invention the timepiece also has an operating unit for operating the timekeeping unit; and a through-hole formed in the glass retaining unit of the retainer ring or the back cover for inserting the stem of the operating unit.

This aspect of the invention renders a hole for inserting the stem of a button, crown, or other operating member for operating the timekeeping unit in the glass retaining unit of the retainer ring or the back cover. It is therefore not necessary to form a hole for inserting the stem of the operating member in the case member, and the strength of a glass case member can therefore be maintained.

Furthermore, because the glass retaining unit of the retainer ring can be made of metal, sufficient strength can be maintained even when such a through-hole is formed.

If the back cover includes a non-magnetic member of glass, for example, and a retaining unit that holds the outside edge of this non-magnetic member, the through-hole can be formed in the retaining unit. Because the retaining unit of the back cover can be made of metal, sufficient strength can be maintained even if such a through-hole is formed in the retaining unit.

Yet further preferably, the operating unit is a non-magnetic member.

The operating unit disposed in the through-hole in the retainer ring or back cover is a non-magnetic member in this aspect of the invention. The antenna can therefore be disposed near the operating unit without the operating unit interfering with signal reception. The signal reception sensitivity of the antenna is therefore good.

Another aspect of the invention is a timepiece that has a retainer ring including a timepiece crystal and a glass retaining unit that holds the outside edge of the crystal; a back cover that is disposed facing the retainer ring; a substantially annular case member that is held between the retainer ring and the back cover; a timekeeping unit that is disposed in the space enclosed between the retainer ring, the back cover, and the case member, and has a time display unit for displaying the time; and an operating unit that is connected to the timekeeping unit and enables controlling the operating content of the timekeeping unit. The case member has a metal part that is formed substantially in a ring from a metal material and has a through-hole for inserting the stem of the operating unit, a substantially annular first glass part that is made from glass at least in part and is disposed between the metal part and the retainer ring, and a substantially annular second glass part that is made from glass at least in part and is disposed between the metal part and the back cover.

The case member of the timepiece according to this aspect of the invention has a substantially annular metal part, a first glass part disposed between this metal part and the retainer ring, and a second glass part disposed between the metal part and the back cover. A through-hole for inserting the stem of the operating unit is formed in the metal part.

As a result, the inside of the timepiece can be seen from the outside through the first and second glass parts, and the unique effect of glass can be used to achieve a nice appearance. Furthermore, because the through-hole is formed in the metal part of the case member, the stem of a crown or other operating member can be inserted through the case member without reducing the durability of the case member. A timepiece with good durability and an excellent appearance can thus be provided.

Yet further preferably, a shock absorbing member is disposed between the first glass part and the retainer ring, between the first glass part and the metal part, between the second glass part and the metal part, and between the second glass part and the back cover.

By thus disposing a shock absorbing member between the metal part of the case member and first and second glass parts, between the retainer ring and the first glass part, and between the back cover and the second glass part, the shock absorbing members attenuate the stress when great stress is applied to the timepiece during timepiece assembly. A high stress load is therefore not applied directly to the first glass part and second glass part, and damage to the first and second glass parts can be prevented.

Yet further preferably, a substantially annular channel is formed following the edge of the case member on the surface of the retainer ring facing the first glass part, the surface of the back cover facing the second glass part, the face of the metal part facing the first glass part, and the face of the metal part facing the second glass part; and the shock absorbing members are disposed in said annular channels.

This aspect of the invention has a groove on the surfaces of the retainer ring and the metal part facing the first glass part, and on the surfaces of the back cover and metal part facing the second glass part, and the shock absorbing members are disposed in these grooves. This avoids problems caused by the shock absorbing members shifting position during timepiece assembly, and effectively prevents applying stress to the first and second glass parts. Furthermore, because the shock absorbing members are disposed along the grooves, the shock absorbing members are difficult to see from the outside and a timepiece with a good appearance can thus be provided.

Yet further preferably, the shock absorbing member is a substantially annular packing member that seals between the first glass part and the retainer ring, between the first glass part and the metal part, between the second glass part and the metal part, and between the second glass part and the back cover.

This aspect of the invention uses packing members as the shock absorbing members. Water resistance can therefore be improved between the first glass part and the retainer ring, between the first glass part and the metal part, between the second glass part and the metal part, and between the second glass part and the back cover.

Yet further preferably, the metal part has an engaging part that engages the first glass part and the second glass part, and positions the first glass part and the second glass part coaxially to the metal part.

In this aspect of the invention the metal part has engaging parts (stops) that position the first glass part and the second glass part. Problems resulting from misalignment of the metal part to the first and second glass parts during timepiece assembly can thus be prevented. If stress is applied to the timepiece from the side, the engaging parts can also prevent the first glass part and the second glass part from shifting sideways. A good appearance can thus be maintained while timepiece durability can also be improved.

Yet further preferably, the glass retaining part of the retainer ring has a back cover locking part that projects toward the back cover, and the protruding distal end of the back cover locking part contacts the back cover and has a screw screwed therein through the back cover; and the case member is held between the glass retaining part of the retainer ring and the back cover with an intervening shock absorbing member.

The back cover locking part in this aspect of the invention can hold a prescribed gap between the retainer ring and the back cover. When the back cover locking part is fastened by screws to the back cover with the case member therebetween, the back cover locking part holds a prescribed gap between the retainer ring and the back cover, and prevents applying excessive stress to the case member. Damage to the first glass part and the second glass part of the case member can also be reliably prevented.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a side section view of a radio-controlled timepiece according to a first embodiment of the invention.

FIG. 2 is an oblique view of the outside case of the radio-controlled timepiece according to a preferred embodiment of the invention.

FIG. 3 is a partially exploded view of the outside case of the radio-controlled timepiece according to a preferred embodiment of the invention.

FIG. 4 is an enlarged section view of the outside circumference part of the outside case of the radio-controlled timepiece according to a preferred embodiment of the invention.

FIG. 5 is a section view showing the fastening structure of the outside circumference part of the outside case of the radio-controlled timepiece according to a preferred embodiment of the invention.

FIG. 6 is a side section view of a timepiece according to a second embodiment of the invention.

FIG. 7 is an oblique view of the outside case of the radio-controlled timepiece according to a second embodiment of the invention.

FIG. 8 is a partially exploded view of the outside case of the radio-controlled timepiece according to a second embodiment of the invention.

FIG. 9 is an enlarged section view of the outside circumference part of the outside case of the radio-controlled timepiece according to a second embodiment of the invention.

FIG. 10 is a section view showing the fastening structure of the outside circumference part of the outside case of the radio-controlled timepiece according to a second embodiment of the invention.

### DESCRIPTION OF THE PREFERRED EMBODIMENTS

### Embodiment 1

A radio-controlled timepiece according to a preferred embodiment of the present invention is described below with reference to the accompanying figures.

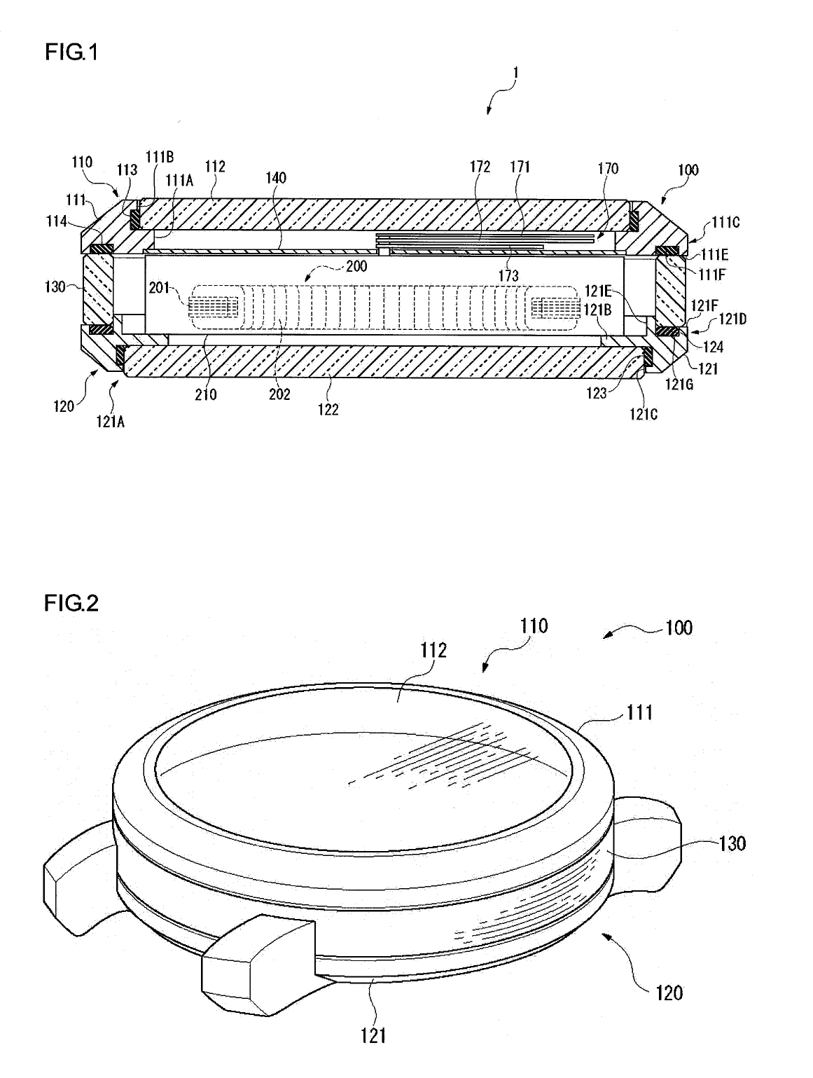

FIG. 1 is a side section view of a radio-controlled timepiece according to a first embodiment of the invention.

FIG. 2 is an oblique view of the outside case of the radio-controlled timepiece according to a preferred embodiment of the invention.

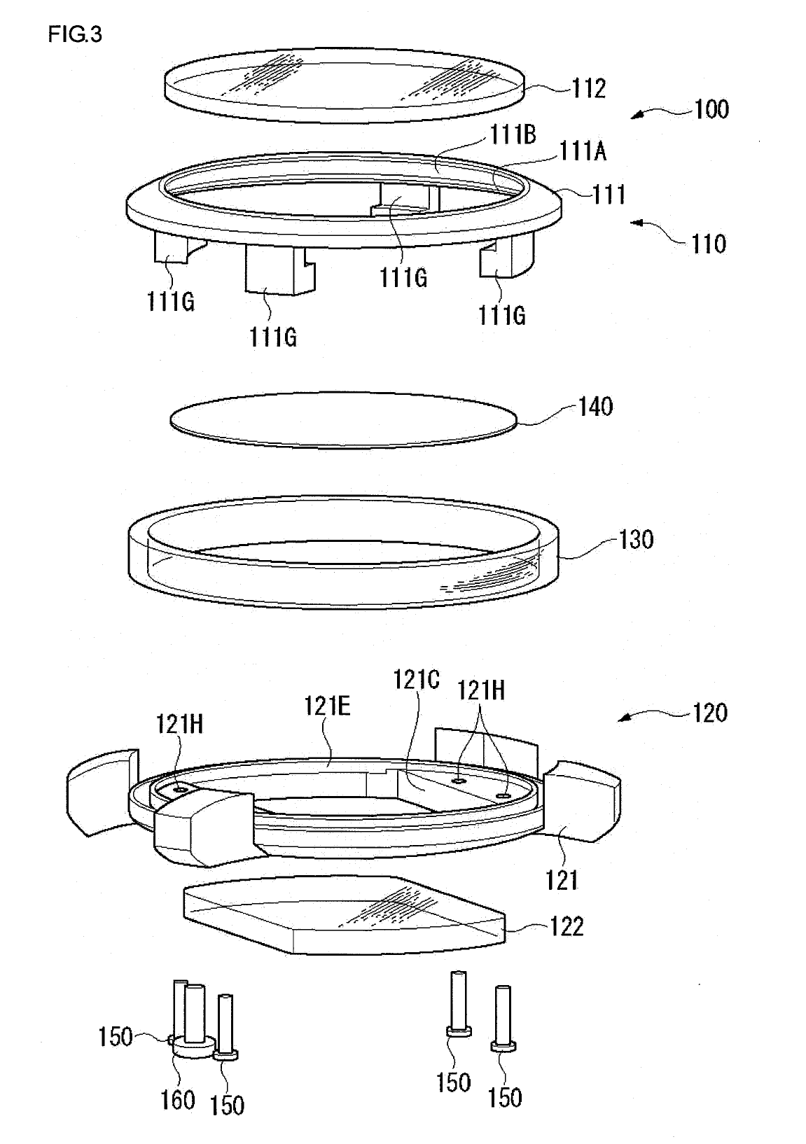

FIG. 3 is a partially exploded view of the outside case of the radio-controlled timepiece according to a preferred embodiment of the invention.

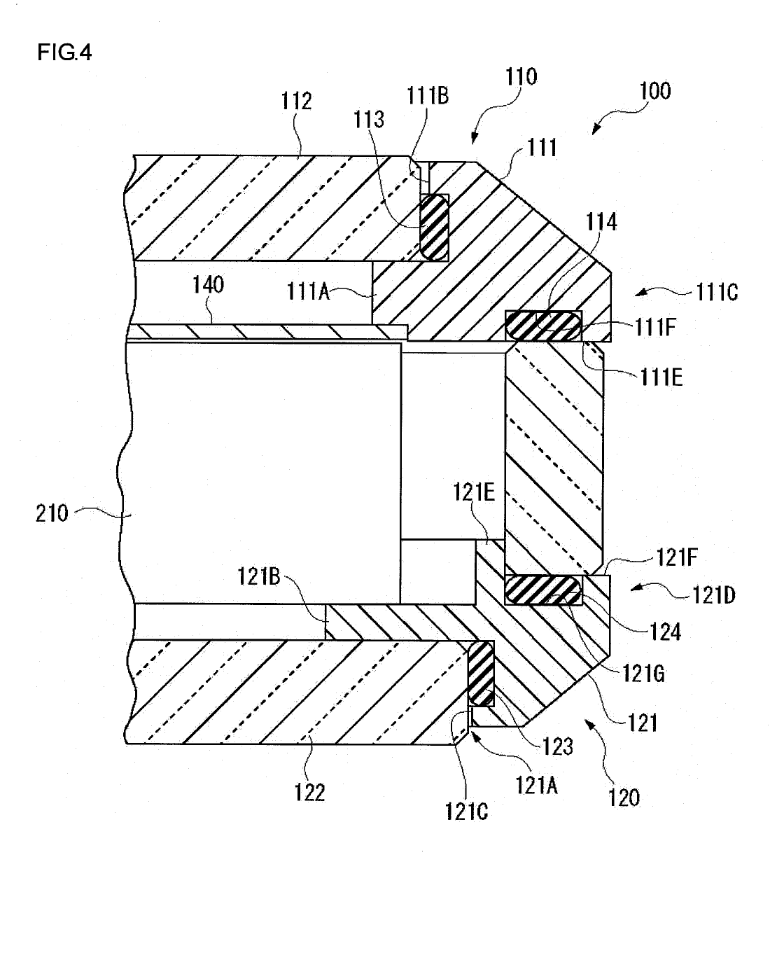

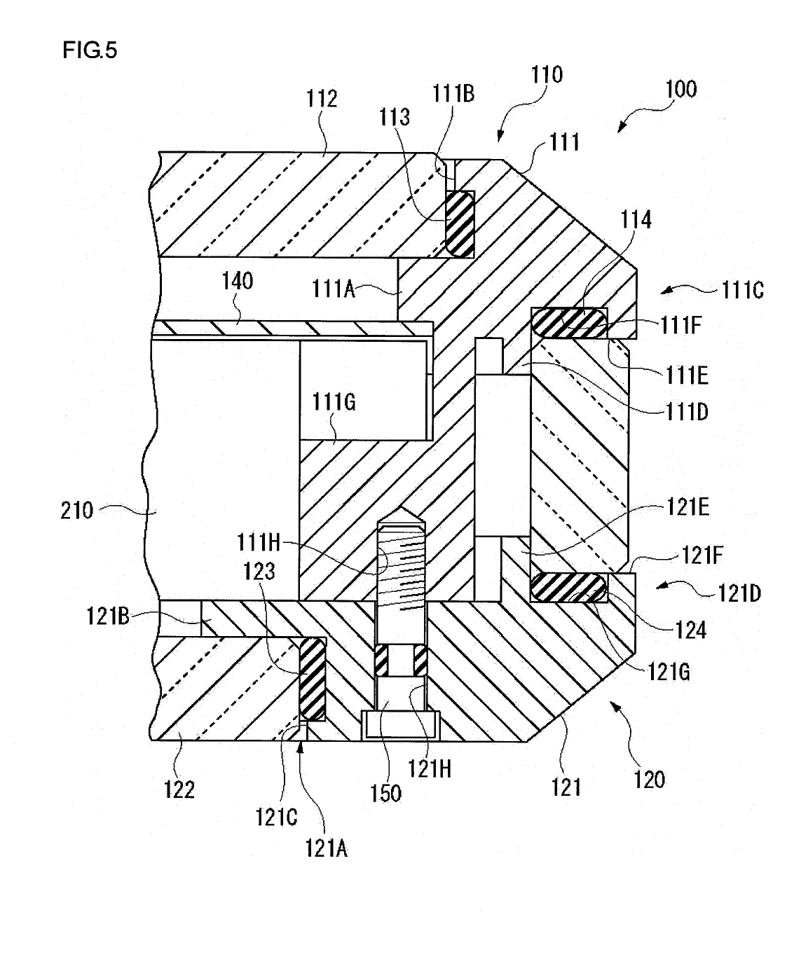

FIG. 4 is an enlarged section view of the outside circumference part of the outside case of the radio-controlled timepiece according to a preferred embodiment of the invention.

FIG. 5 is a section view showing the fastening structure of the outside circumference part of the outside case of the radio-controlled timepiece according to a preferred embodiment of the invention.

As shown in FIG. 1, the radio-controlled timepiece 1 according to this embodiment of the invention has an outside case 100, an antenna 200 disposed inside the outside case 100, and a movement 210 as the timekeeping mechanism.

The outside case 100 includes a retainer ring 110, a back cover 120 disposed opposite the retainer ring 110, and a case body 130 that is held between the retainer ring 110 and the back cover 120.

As shown in FIG. 1 to FIG. 5, the retainer ring 110 has a bezel 111 as a watch crystal retainer unit, and a watch crystal 112.

In this embodiment of the invention the bezel 111 is substantially round and is made of metal or other strong material.

A shoulder 111A is formed around the inside circumference surface of the bezel 111 for supporting the crystal 112 thereon. Packing 113 is disposed between the inside circumference surface (crystal support surface 111B) of the bezel 111 and the outside circumference edge of the crystal 112.

A bezel-side case retainer 111C for holding the case body 130 is formed around the outside edge of the bezel 111 on the bottom (the side facing the back cover 120). The bezel-side case retainer 111C has a bezel-side stop 111D protruding towards the back cover 120, and a bezel-side retaining surface 111E on the outside circumference side of the bezel-side stop 111D.

The bezel-side stop 111D is disposed, for example, at four locations circumferentially to the bezel-side case retainer 111C, and contacts the inside circumference surface of the case body 130 for positioning. Note that the bezel-side stop 111D is formed at four locations in this embodiment, but the invention is not so limited. For example, there could be three or five or more discretely formed bezel-side stops 111D, or the bezel-side stop 111D could be formed as a single continuous stop around the circumference of the bezel 111.

A bezel-side retainer channel 111F formed substantially around the circumference of the bezel-side retaining surface 111E renders a recessed channel that is open to the back cover 120 side. A bezel-side packing member 114 is disposed as a shock absorber made of rubber, plastic, or other elastic material inside this bezel-side retainer channel 111F. The bezel-side packing member 114 is formed with a substantially circular section that is substantially equal in diameter to the width of the bezel-side retainer channel 111F. As a result, when stress is applied to the bezel-side packing member 114 in the axial direction, deflection substantially perpendicularly to the axial direction is limited by the side walls of the bezel-side retainer channel 111F, and thus increases the elastic resilience of the bezel-side packing member 114 in line with the axial direction.

The bezel-side case retainer 111C holds the case body 130 secure by means of the bezel-side stop 111D positioned in contact with the inside surface of the case body 130 and the case body 130 being held between the bezel-side retaining surface 111E and the back cover 120 through the intervening bezel-side packing member 114.

Four back cover retaining flanges 111G are disposed protruding down as shown in FIG. 5 from the inside surface of the bezel-side case retainer 111C of the bezel 111. A screw hole 111H is formed in the bottom surface of each back cover retaining flange 111G facing the back cover 120. The bottom of these back cover retaining flanges 111G is placed against the top of the back cover 120, and a set screw 150 inserted from the bottom of the back cover 120 is screwed into each screw hole 111H to fasten the back cover 120.

The back cover retaining flanges 111G are disposed at positions substantially corresponding to the bezel-side stops 111D, but the invention is not so limited and the back cover retaining flanges 111G and the bezel-side stops 111D do not need to be in opposing positions. The number of back cover retaining flanges 111G is also not limited to four, but there must be at least three, and there could therefore be only three or five or more back cover retaining flanges 111G.

The crystal 112 is placed on and bonded by adhesive to the shoulder 111A of the bezel 111. Packing 113 is disposed between the crystal 112 and the crystal retaining face 111B of the bezel 111 in order to prevent water from entering between the bezel 111 and the crystal 112 and provide the desired water resistance.

The back cover 120 includes a back cover retaining ring 121 and a glass cover 122 that is held in the back cover retaining ring 121.

The back cover retaining ring 121 is made of a high strength material such as metal. A substantially square glass retaining hole 121A is formed substantially in the center of the back cover retaining ring 121. A glass positioning flange 121B protruding toward the inside is formed at the top edge of the glass retaining hole 121A. A substantially square glass cover 122 substantially identical in shape to the glass retaining hole 121A is positioned against the bottom of this glass positioning flange 121B, and affixed thereto by adhesive, for example. A glass cover retaining surface 121C that holds the outside edge of the glass cover 122 is formed at the bottom of the inside surface of the glass retaining hole 121A. The glass cover retaining surface 121C holds the edge of the glass cover 122 with intervening packing 123.

A back-cover-side case retainer 121D is formed around the outside edge at the top of the back cover 120 as shown in FIG. 1, FIG. 4, and FIG. 5. The back-cover-side case retainer 121D has a back-cover-side stop 121E that protrudes toward the retainer ring 110, and a back-cover-side retainer face 121F rendered on the outside circumference side of the back-cover-side stop 121E.

The back-cover-side stop 121E is formed circumferentially to the outside circumference of the back-cover-side case retainer 121D. The back-cover-side stop 121E contacts the inside circumference of the case body 130 and positions the case body 130. The back-cover-side stop 121E is rendered around the entire circumference of the back-cover-side case retainer 121D in this embodiment of the invention, but the invention is not so limited and the back-cover-side stop 121E could be formed similarly to the bezel-side stop 111D at, for example, four locations around the circumference of the back-cover-side case retainer 121D.

The back-cover-side retainer face 121F has a back-cover-side retainer channel 121G as a groove that is open to the retainer ring 110 side. A bezel-side packing member 114 is disposed as a shock absorber made of rubber, plastic, or other elastic material inside this bezel-side retainer channel 111F. A back-cover-side packing member 124 is disposed as a shock absorber made of rubber, plastic, or other elastic material in this back-cover-side retainer channel 121G. Like the bezel-side packing member 114 described above, the back-cover-side packing member 124 is formed with a substantially circular section that is substantially equal in diameter to the width of the back-cover-side retainer channel 121G. As a result, when stress is applied to the back-cover-side packing member 124 in the axial direction, deflection substantially perpendicularly to the axial direction is limited by the side walls of the back-cover-side retainer channel 121G, and the elastic resilience of the bezel-side packing member 114 in line with the axial direction.

The back-cover-side case retainer 121D holds the case body 130 secure by means of the back-cover-side stop 121E positioned in contact with the inside surface of the case body 130 and the case body 130 held between the back-cover-side retainer face 121F and the bezel-side retaining surface 111E of the retainer ring 110 through the intervening back-cover-side packing member 124.

Screw holes 121H for inserting the set screws 150 described above are formed in the back cover retaining ring 121 as shown in FIG. 5 at positions corresponding to the back cover retaining flanges 111G of the retainer ring 110.

As described above, a set screw 150 is inserted to the screw hole 121H and the set screw 150 is screwed into the screw hole 111H in the back cover retaining flanges 111G. The back cover 120 and retainer ring 110 are thus held together with the case body 130 therebetween.

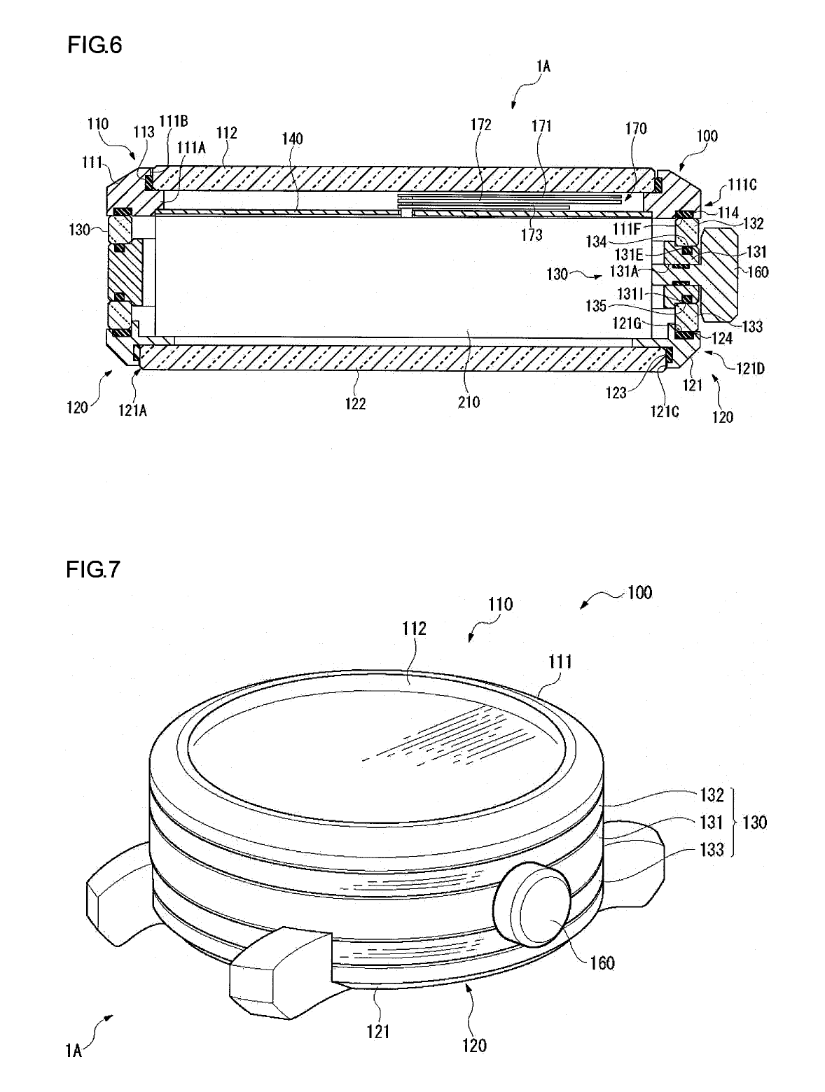

As shown in FIG. 3 and FIG. 6, a through-hole not shown for inserting the stem of a crown 160 as an operating member is formed in the back cover retaining ring 121.

The case body 130 is made of glass and is substantially ring shaped, and is held between the back cover 120 and the bezel 111 of the retainer ring 110. As described above, the case body 130 is held by means of the retainer ring 110 and the back cover 120 with the intervening bezel-side packing member 114 and back-cover-side packing member 124. Stress applied to the retainer ring 110 and back cover 120 is thus absorbed by the packing members 114 and 124, and the case body 130 is thus protected from great stress and damage.

As described above, the stem of the crown 160 is inserted through a through-hole and connected to a movement 210 that is the timekeeping unit disposed inside the outside case 100. The crown 160 can be rendered to operate in many ways, including outputting signals to a control circuit (not shown) located inside the movement 210 when the crown 160 is pushed in or pulled out from the movement 210, or outputting operating signals to the control circuit unit when the crown 160 is rotatably disposed and the crown 160 is wound.

A dial 140 is disposed facing the crystal 112 between the retainer ring 110 and the movement 210. This dial 140 is made from plastic or other nonmagnetic material, and is fixed to the top of the movement 210. A through-hole not shown is formed substantially in the center of the dial 140, and the center pin on which the hands 170 are mounted above the dial 140 passes through this hole.

As shown in FIG. 1, the antenna 200 has a magnetic core 201 and a coil 202 wound around the magnetic core 201, and is formed in an arc along the inside circumference face of the case body 130, for example. This antenna 200 receives a radio frequency signal (external radio frequency information), and in this embodiment of the invention more particularly receives standard time signals that are transmitted from a known standard time signal broadcasting station and carry time information. The received signals are output to a control circuit unit not shown that is built in to the movement 210.

The movement 210 is housed inside the outside case 100 and is affixed at a prescribed position inside the outside case 100.

The movement 210 includes a control circuit unit not shown for processing the standard time signals received by the antenna 200, a stepping motor not shown that is driven as controlled by the control circuit unit, and hands 170 (including a second hand 171, an hour hand 173, and a minute hand 172 as shown in FIG. 1) that are driven by drive power from the stepping motor.

The movement 210 keeps the time by means of a counter not shown that is part of the control circuit unit, outputs a predetermined pulse signal to the stepping motor according to the counted time, and thus moves the hands 170. Based on the time information in the standard time signal received by the antenna 200, the movement 210 appropriately drives the stepping motor and controls moving the hands 170 to the hand positions corresponding to the time information in the standard time signal.

Assembling the Outside Case of the Radio-Controlled Timepiece

A preferred method of assembling the outside case 100 of the radio-controlled timepiece 1 according to this embodiment of the invention is described next.

To assemble the radio-controlled timepiece 1, the crystal 112 is first fit into the bezel 111 of the retainer ring 110 to assemble the retainer ring 110, and the glass cover 122 is fit into the back cover retaining ring 121 of the back cover 120 to assemble the back cover 120. The bezel-side packing member 114 is then fit into the bezel-side retainer channel 111F of the retainer ring 110, and the back-cover-side packing member 124 is fit into the back-cover-side retainer channel 121G of the back cover 120.

The movement 210, to which the hands 170 and dial 140 have been attached, is then attached to the retainer ring 110.

The case body 130 is then mounted on the bezel-side retaining surface 111E of the retainer ring 110. The bezel-side stop 111D is set against the inside surface of the case body 130 at this time to position the case body 130.

The case body 130 is then covered by the back cover 120, and the case body 130 is affixed between the back cover 120 and the retainer ring 110. The back-cover-side stop 121E of the back cover 120 is set against the inside circumference surface of the case body 130 at this time.

The set screws 150 are then passed through the screw holes 121H in the back cover 120, and screwed into the screw holes 111H in the back cover retaining flanges 111G of the retainer ring 110. Tightening the set screws 150 holds the case body 130 firmly between the retainer ring 110 and the back cover 120. Because the case body 130 is held between the retainer ring 110 and the back cover 120 with the intervening bezel-side packing member 114 and back-cover-side packing member 124, the load on the case body 130 is absorbed by the elastic deformation of the packing members 114 and 124.

Effect of the Radio-Controlled Timepiece

As described above, the outside case 100 of the radio-controlled timepiece 1 according to this embodiment of the invention has a retainer ring 110 with a crystal 112, a back cover 120 opposite the retainer ring 110, and a glass case body 130 that is a non-magnetic member held between the retainer ring 110 and back cover 120. An antenna 200 for receiving standard time signals and a movement 210 are disposed inside the outside case 100. The movement 210 sets the time based on the time information from the standard time signal received through the antenna 200, and drives the hands 170 to display the time kept by an internal timekeeping unit.

By thus rendering the case body 130 from a non-magnetic material, the case body 130 does not interfere with standard time signal reception, a strong standard time signal can be received by the antenna 200, and the reception sensitivity of the antenna 200 can be improved.

Furthermore, because the case body 130 does not contact the skin when the radio-controlled timepiece 1 is rendered as a wristwatch and is worn with the back cover 120 against the skin, radio frequency signals pass easily through the case body 130 and good reception sensitivity can be achieved even when the invention is applied to a GPS wristwatch or other application that receives signals that can be affected by the body.

Good reception sensitivity can also be achieved even when the back cover 120 on the opposite side of the radio-controlled timepiece 1 as the retainer ring 110 is placed on a stand or other surface made of a non-magnetic material because the case body 130 is non-magnetic and the radio frequency signals can be received through the case body 130.

The case body 130 is made from a glass ring.

The case body 130 is thus assured of greater strength than if the case body 130 is rendered using a C-shaped glass member, for example. Furthermore, because standard time signals can pass through the case body 130 around its entire circumference, the reception sensitivity of the antenna can be yet further improved.

The case body 130 is made of glass.

This enables seeing inside the timepiece from the side. The sense of quality that is unique to glass also improves the aesthetic design, and thus affords a radio-controlled timepiece 1 with an outstanding design.

The back cover 120 includes a glass cover 122 made of glass, and a back cover retaining ring 121 that protects the outside edge of the glass cover 122.

This improves the reception sensitivity of the antenna 200 when the antenna 200 is disposed near the back cover compared with an arrangement in which all of the back cover 120 is made of metal or other magnetic material.

The dial 140 is made from a non-magnetic member.

Compared with using a dial 140 that is made of metal, for example, the arrangement of the invention affords better reception sensitivity even when the antenna 200 is located near the dial 140 because the dial 140 does not interfere with signal reception.

A through-hole is formed in the back cover retaining ring 121 of the back cover 120, and the stem of the crown 160 passes through this hole.

By thus rendering the stem hole in the high strength back cover retaining ring 121 and passing the stem of the crown 160 through this hole, there is no need to render a hole in the glass case body 130, and loss of strength in the case body 130 can thus be prevented. Furthermore, by rendering the through-hole in the back cover retaining ring 121 part of the back cover 120, which is made of metal, the durability of the back cover 120 is not impaired and the durability of the timepiece can be improved.

The crown 160 is made of a non-magnetic member. The crown 160 therefore does not interfere with radio signal reception even when the antenna 200 is disposed near the crown 160, and the reception sensitivity of the antenna 200 can therefore be improved.

The case body 130 is held between the retainer ring 110 and the back cover 120 by means of intervening bezel-side packing member 114 and back-cover-side packing member 124.

The packing members 114 and 124 thus form a good water-resistant seal between the case body 130 and the retainer ring 110 and between the case body 130 and the back cover 120. Furthermore, by inserting the packing members 114 and 124 between the case body 130 and the retainer ring 110 and back cover 120, the case body 130 does not directly contact the retainer ring 110 or the 120, stress on the case body 130 is dispersed by the packing members 114 and 124, and damage to the case body 130 when assembling the outside case 100 can be prevented.

The bezel-side packing member 114 and the back-cover-side packing member 124 are disposed in the mutually opposing annular bezel-side retainer channel 111F and back-cover-side retainer channel 121G.

As a result, the packing members 114 and 124 can be desirably positioned between the retainer ring 110 and case body 130 and between the back cover 120 and case body 130 without shifting radially. A loss of water resistance and a drop in strength caused by shifting of the packing members 114 and 124 can therefore be prevented and a good appearance can be achieved.

In addition, the packing members 114 and 124 are basically circular in section with a diameter that is substantially equal to the width of the bezel-side retainer channel 111F and back-cover-side retainer channel 121G. As a result, when the packing members 114 and 124 are fit into the matching bezel-side retainer channel 111F and back-cover-side retainer channel 121G, and the case body 130 is held between the retainer ring 110 and the back cover 120, elastic deformation radially to the packing members 114 and 124 is restricted by the side walls of the bezel-side retainer channel 111F and back-cover-side retainer channel 121G, and elastic resilience in the axial direction can therefore be improved. The application of stress to the case body 130 can therefore be more effectively prevented, and damage to the case body 130 can be reliably prevented.

The outside case 100 is assembled to hold the case body 130 between the back cover 120 and the retainer ring 110 by passing set screws 150 through the screw holes 121H disposed in the back cover 120 and threading the set screws 150 into screw holes 111H in the back cover retaining flanges 111G of the retainer ring 110.

The back cover 120 and retainer ring 110 can thus be reliably and firmly fastened by means of set screws. Because the case body 130 is held between the retainer ring 110 and back cover 120 by intervening packing members 114 and 124 as described above, stress applied axially to the case body 130 by tightening the screws is dispersed by the packing members 114 and 124, thereby reducing the stress on the case body 130 and preventing damage to the case body 130.

### Embodiment 2

A radio-controlled timepiece according to a second embodiment of the invention is described next with reference to the accompanying figures.

FIG. 6 is a side section view of a timepiece according to a second embodiment of the invention.

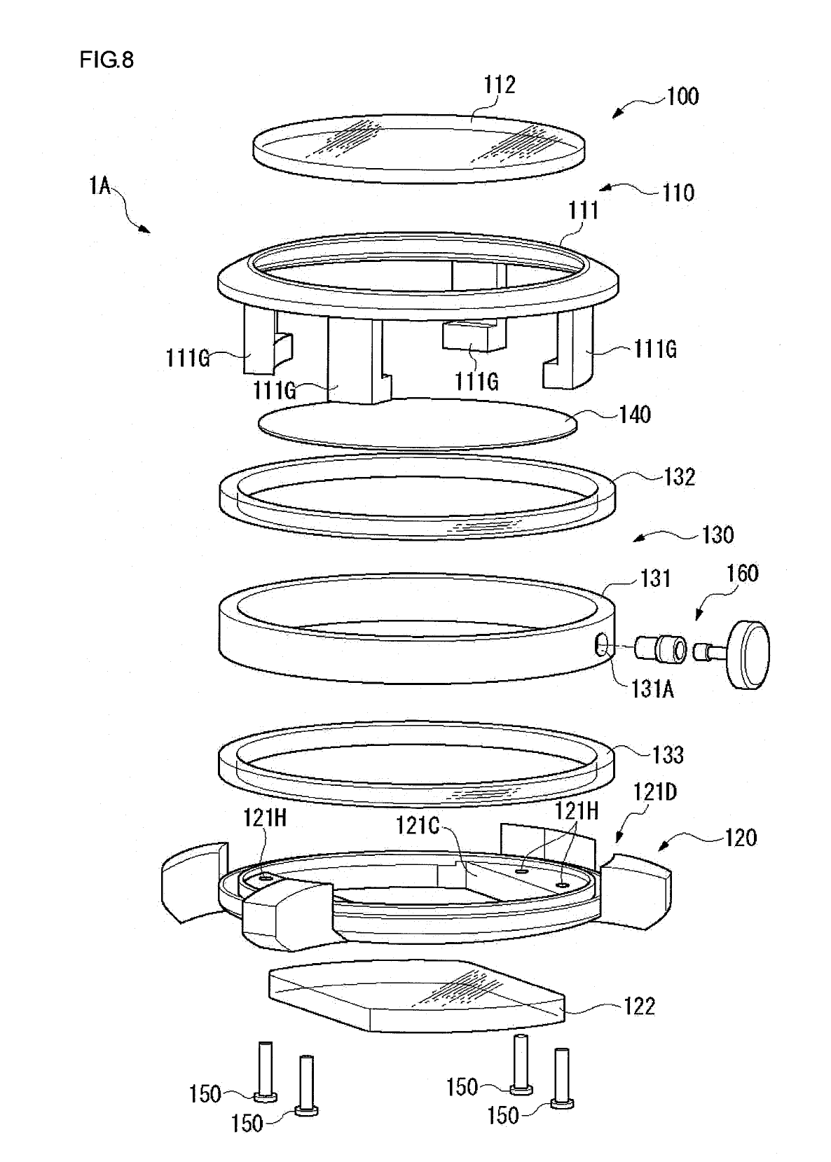

FIG. 7 is an oblique view of the outside case of the radio-controlled timepiece according to a second embodiment of the invention.

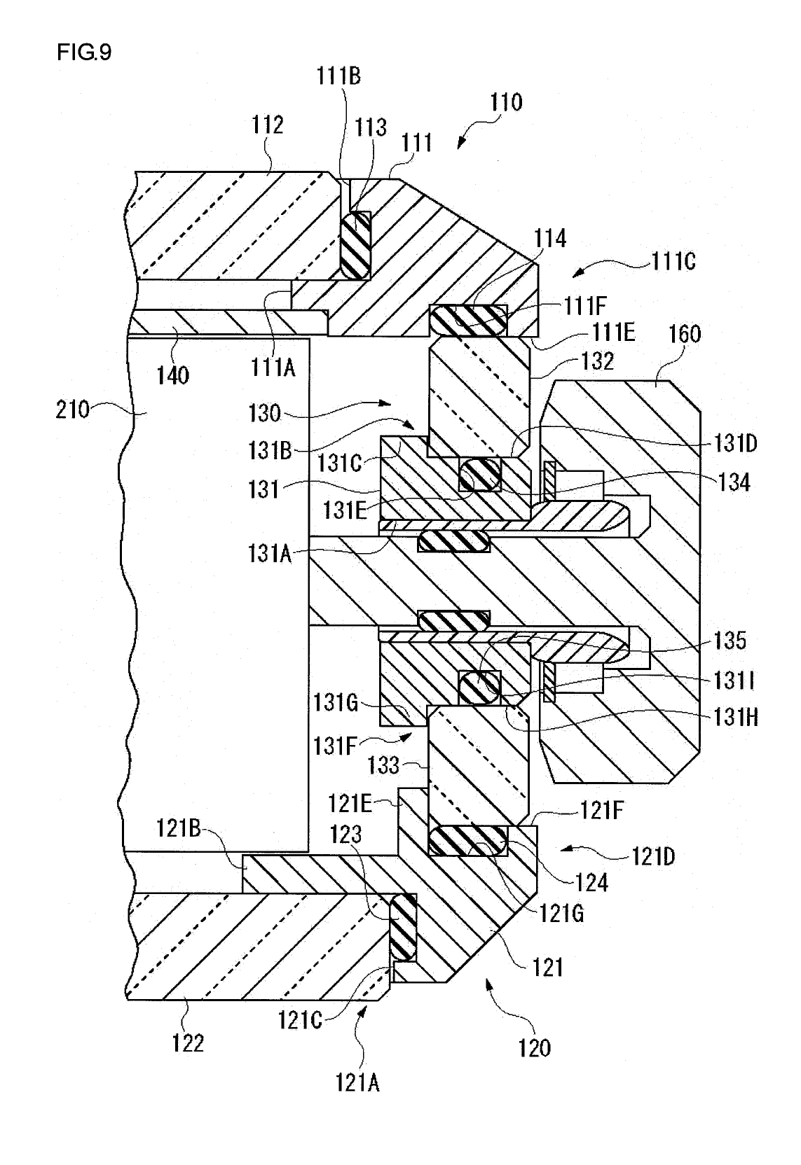

FIG. 8 is a partially exploded view of the outside case of the radio-controlled timepiece according to a second embodiment of the invention.

FIG. 9 is an enlarged section view of the outside circumference part of the outside case of the radio-controlled timepiece according to a second embodiment of the invention.

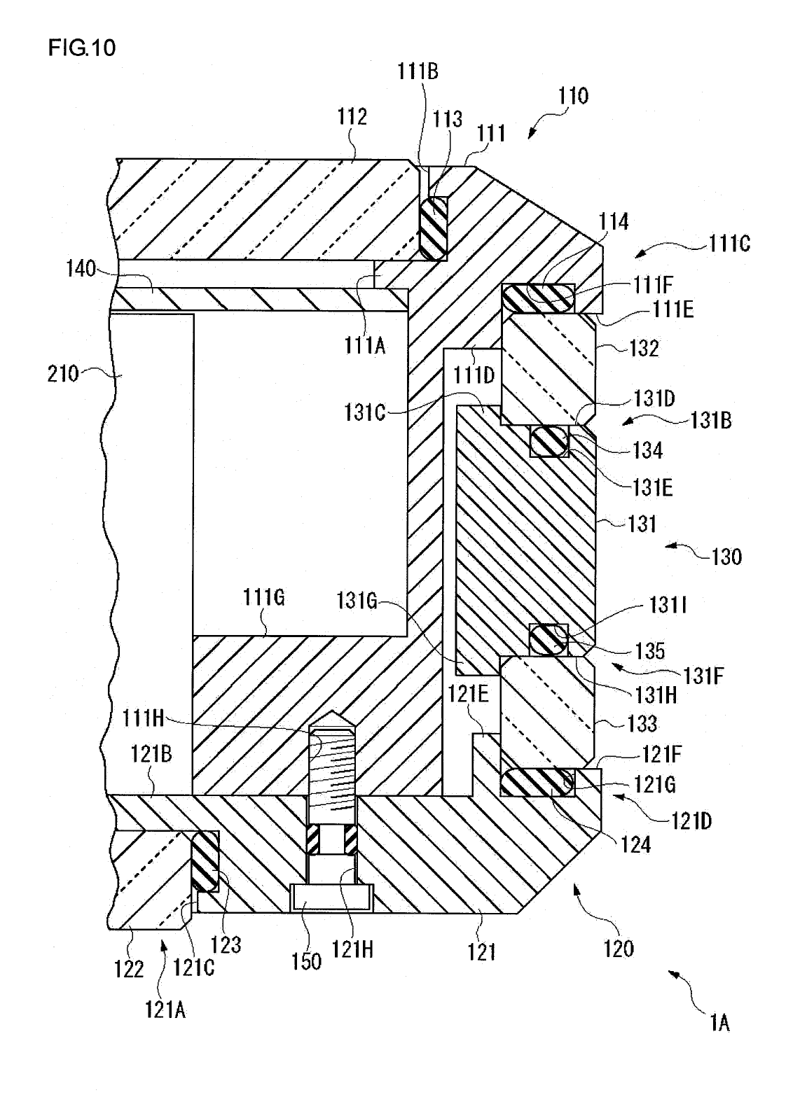

FIG. 10 is a section view showing the fastening structure of the outside circumference part of the outside case of the radio-controlled timepiece according to a second embodiment of the invention.

Timepiece Arrangement

As shown in FIG. 6, the timepiece 1A according to this embodiment of the invention has an outside case 100 and a movement 210 as the timekeeping mechanism.

The outside case 100 includes a retainer ring 110, a back cover 120 disposed opposite the retainer ring 110, and a case body 130 that is held between the retainer ring 110 and the back cover 120.

As shown in FIG. 6 to FIG. 10, the retainer ring 110 has a bezel 111 as a watch crystal retainer unit, and a watch crystal 112.

In this embodiment of the invention the bezel 111 is substantially round and is made of metal or other strong material.

A shoulder 111A is formed around the inside circumference surface of the bezel 111 for supporting the crystal 112 thereon. Packing 113 is disposed between the inside circumference surface (crystal support surface 111B) of the bezel 111 and the outside circumference edge of the crystal 112.

A bezel-side case retainer 111C for holding the first glass part 132 of the case body 130 is formed around the outside edge of the bezel 111 on the bottom (the side facing the back cover 120). The bezel-side case retainer 111C has a bezel-side stop 111D protruding towards the back cover 120, and a bezel-side retaining surface 111E on the outside circumference side of the bezel-side stop 111D.

The bezel-side stop 111D is disposed, for example, at four locations circumferentially to the bezel-side case retainer 111C, and contacts the inside circumference surface of the case body 130 for positioning. Note that the bezel-side stop 111D is formed at four locations in this embodiment, but the invention is not so limited. For example, there could be three or five or more discretely formed bezel-side stops 111D, or the bezel-side stop 111D could be formed as a single continuous stop around the circumference of the bezel 111.

A bezel-side retainer channel 111F formed substantially around the circumference of the bezel-side retaining surface 111E renders a recessed channel that is open to the back cover 120 side. A bezel-side packing member 114 is disposed as a shock absorber made of rubber, plastic, or other elastic material inside this bezel-side retainer channel 111F. The bezel-side packing member 114 is formed with a substantially circular section that is substantially equal in diameter to the width of the bezel-side retainer channel 111F. As a result, when stress is applied to the bezel-side packing member 114 in the axial direction, deflection substantially perpendicularly to the axial direction is limited by the side walls of the bezel-side retainer channel 111F, and thus increases the elastic resilience of the bezel-side packing member 114 in line with the axial direction.

The bezel-side case retainer 111C holds the case body 130 secure by means of the bezel-side stop 111D positioned in contact with the inside surface of the case body 130 and the case body 130 being held between the bezel-side retaining surface 111E and the back cover 120 through the intervening bezel-side packing member 114.

Four back cover retaining flanges 111G are disposed protruding down as shown in FIG. 10 from the inside surface of the bezel-side case retainer 111C of the bezel 111. A screw hole 111H is formed in the bottom surface of each back cover retaining flange 111G facing the back cover 120. The bottom of these back cover retaining flanges 111G is placed against the top of the back cover 120, and a set screw 150 inserted from the bottom of the back cover 120 is screwed into each screw hole 111H to fasten the back cover 120.

The back cover retaining flanges 111G are disposed at positions substantially corresponding to the bezel-side stops 111D, but the invention is not so limited and the back cover retaining flanges 111G and the bezel-side stops 111D do not need to be in opposing positions. The number of back cover retaining flanges 111G is also not limited to four, but there must be at least three, and there could therefore be only three or five or more back cover retaining flanges 111G.

The crystal 112 is placed on and bonded by adhesive to the shoulder 111A of the bezel 111. Packing 113 is disposed between the crystal 112 and the crystal retaining face 111B of the bezel 111 in order to prevent water from entering between the bezel 111 and the crystal 112 and provide the desired water resistance.

The back cover 120 includes a back cover retaining ring 121 and a glass cover 122 that is held in the back cover retaining ring 121.

The back cover retaining ring 121 is made of a high strength material such as metal. A substantially square glass retaining hole 121A is formed substantially in the center of the back cover retaining ring 121. A glass positioning flange 121B protruding toward the inside is formed at the top edge of the glass retaining hole 121A. A substantially square glass cover 122 substantially identical in shape to the glass retaining hole 121A is positioned against the bottom of this glass positioning flange 121B, and affixed thereto by adhesive, for example. A glass cover retaining surface 121C that holds the outside edge of the glass cover 122 is formed at the bottom of the inside surface of the glass retaining hole 121A. The glass cover retaining surface 121C holds the edge of the glass cover 122 with intervening packing 123.

A back-cover-side case retainer 121D is formed at the top around the outside edge of the back cover 120 as shown in FIG. 6, FIG. 9, and FIG. 10. The back-cover-side case retainer 121D has a back-cover-side stop 121E that protrudes toward the retainer ring 110, and a back-cover-side retainer face 121F rendered on the outside circumference side of the back-cover-side stop 121E.

The back-cover-side stop 121E is formed circumferentially to the outside circumference of the back-cover-side case retainer 121D. The back-cover-side stop 121E contacts the inside circumference of the case body 130 and positions the case body 130. The back-cover-side stop 121E is rendered around the entire circumference of the back-cover-side case retainer 121D in this embodiment of the invention, but the invention is not so limited and the back-cover-side stop 121E could be formed similarly to the bezel-side stop 111D at, for example, four locations around the circumference of the back-cover-side case retainer 121D.

The back-cover-side retainer face 121F has a back-cover-side retainer channel 121G as a groove that is open to the retainer ring 110 side. A bezel-side packing member 114 is disposed as a shock absorber made of rubber, plastic, or other elastic material inside this bezel-side retainer channel 111F. A back-cover-side packing member 124 is disposed as a shock absorber made of rubber, plastic, or other elastic material in this back-cover-side retainer channel 121G. Like the bezel-side packing member 114 described above, the back-cover-side packing member 124 is formed with a substantially circular section that is substantially equal in diameter to the width of the back-cover-side retainer channel 121G. As a result, when stress is applied to the back-cover-side packing member 124 in the axial direction, deflection substantially perpendicularly to the axial direction is limited by the side walls of the back-cover-side retainer channel 121G, and the elastic resilience of the bezel-side packing member 114 in line with the axial direction.

The back-cover-side case retainer 121D holds the case body 130 secure by means of the back-cover-side stop 121E positioned in contact with the inside surface of the case body 130 and the case body 130 held between the back-cover-side retainer face 121F and the bezel-side retaining surface 111E of the retainer ring 110 through the intervening back-cover-side packing member 124.

Screw holes 121H for inserting the set screws 150 described above are formed in the back cover retaining ring 121 as shown in FIG. 5 at positions corresponding to the back cover retaining flanges 111G of the retainer ring 110.

As described above, a set screw 150 is inserted to the screw hole 121H and the set screw 150 is screwed into the screw hole 111H in the back cover retaining flanges 111G. The back cover 120 and retainer ring 110 are thus held together with the case body 130 therebetween.

The case body 130 has a substantially annular metal part 131, a first glass part 132 disposed on the retainer ring 110 side of this metal part 131, and a second glass part 133 disposed on the back cover 120 side of the metal part 131.

The metal part 131 is made of titanium or other metal, a through-hole 131A for inserting the stem of a crown 160 as an operating member is formed passing through the metal part 131.

A first glass retaining unit 131B is disposed to the metal part 131 on the end opposite the first glass part 132, and a second glass retaining unit 131F is disposed on the opposite end facing the second glass part 133.

The first glass retaining unit 131B has a first glass stop 131C that protrudes toward the retainer ring 110 and functions as a stop, and a first glass retaining surface 131D formed on the outside circumference side of the first glass stop 131C.

A first glass stop 131C is rendered at four locations around the circumference of the metal part 131 to contact the inside circumference surface of the first glass part 132 and position the first glass part 132. Note that the first glass stops 131C are formed at four locations in this embodiment, but the invention is not so limited. For example, there could be three or five or more discretely formed first glass stops 131C, or the first glass stop 131C could be formed as a single continuous stop around the circumference of the first glass retaining unit 131B.

A first glass retaining channel 131E formed circumferentially to the first glass retaining surface 131D renders a recessed channel that is open to the retainer ring 110 side. A first glass retaining packing member 134 is disposed as a shock absorber made of rubber, plastic, or other elastic material inside this first glass retaining channel 131E. The first glass retaining packing member 134 is formed with a substantially circular section that is substantially equal in diameter to the width of the first glass retaining channel 131E. As a result, when stress is applied to the first glass retaining packing member 134 in the axial direction, deflection substantially perpendicularly to the axial direction is limited by the side walls of the first glass retaining channel 131E, and thus increases the elastic resilience of the first glass retaining packing member 134 in line with the axial direction.

The second glass retaining unit 131F is substantially identical to the first glass retaining unit 131B, and has a second glass stop 131G that protrudes toward the back cover 120 and functions as a stop, and a second glass retaining surface 131H formed on the outside circumference side of the second glass stop 131G.

A second glass stop 131G is rendered at four locations around the circumference of the metal part 131 to contact the inside circumference surface of the second glass part 133 and position the second glass part 133. Note that like the first glass stops 131C, second glass stops 131G are formed at four locations in this embodiment, but the invention is not so limited. For example, there could be three or five or more discretely formed second glass stops 131G, or the second glass stop 131G could be formed as a single continuous stop around the circumference of the second glass retaining unit 131F.

A second glass retaining channel 1311 formed circumferentially to the second glass retaining surface renders a recessed channel that is open to the back cover 120 side. A second glass retaining packing member 135 is disposed as a shock absorber made of rubber, plastic, or other elastic material inside this second glass retaining channel 1311. The second glass retaining packing member 135 is formed with a substantially circular section that is substantially equal in diameter to the width of the second glass retaining channel 1311.

The first glass part 132 is made of glass and is substantially ring shaped, is substantially equal in diameter to the metal part 131, and is disposed substantially coaxially to the metal part 131. Sapphire glass, crystal glass, or other type of glass could be used to make the first glass part 132. As described above, the inside surface of the first glass part 132 is positioned by the first glass stop 131C of the metal part 131 and the bezel-side stop 111D of the retainer ring 110. The first glass part 132 is held between the retainer ring 110 and the metal part 131 by means of the bezel-side packing member 114 and the first glass retaining packing member 134. Stress from the retainer ring 110 and metal part 131 is therefore absorbed by the packing members 114 and 134 and the first glass part 132 is thus protected from great stress and damage.

Similarly to the first glass part 132, the second glass part 133 is made of glass and is substantially ring shaped, is substantially equal in diameter to the metal part 131, and is disposed substantially coaxially to the metal part 131. Like the first glass part 132, the second glass part 133 is also made of sapphire glass, crystal glass, or other type of glass. As described above, the inside surface of the second glass part 133 is positioned by the second glass stop 131G of the metal part 131 and the back-cover-side stop 121E of the back cover 120 (see FIG. 9). The second glass part 133 is held between the back cover 120 and the metal part 131 by means of the back-cover-side packing member 124 and second glass retaining packing member 135. Similarly to the first glass part 132, stress from the back cover 120 and the metal part 131 is therefore absorbed by the packing members 124 and 135 and the second glass part 133 is thus protected from great stress and damage.

As described above, the stem of the crown 160 is inserted through a through-hole 131A formed in the metal part 131 of the case body 130 as described above, and connected to the movement 210. The crown 160 outputs predetermined operating signals to a control circuit unit disposed in the movement 210 when the crown 160 is operated by the user. Note that while a crown 160 is shown as the operating member by way of example, push-button switches that move in and out of the movement 210 can be used instead.

A dial 140 is disposed facing the crystal 112 between the retainer ring 110 and the movement 210. This dial 140 is made from plastic or other nonmagnetic material, and is fixed to the top of the movement 210. A through-hole not shown is formed substantially in the center of the dial 140, and the center pin on which the hands 170 are mounted above the dial 140 passes through this hole.

The movement 210 has an internal control circuit unit not shown, and moves the hands 170 by driving a stepping motor (not shown in the figure), for example, according to the operating signals input from the crown 160. The movement 210 includes a crystal oscillator, for example, and drives the hands 170 at a predetermined drive interval. The movement 210 in this embodiment of the invention is for an electronically controlled mechanical timepiece that controls driving the hands 170 by means of a motor based on an operating signal input from the crown 160, but the invention is not so limited and the movement could be for a mechanical timepiece, an analog quartz type, or a timepiece driven by a different method. Furthermore, because radio frequency reception sensitivity is good as a result of the first and second glass parts 132 and 133 of the case body 130, the movement 210 and timepiece of the invention can be beneficially used in a so-called radio-controlled timepiece that receives a standard time signal carrying time information and sets the time based on the received time information.

Assembling the Outside Case of the Timepiece

A preferred method of assembling the outside case 100 of the radio-controlled timepiece 1A according to this embodiment of the invention is described next.

To assemble the radio-controlled timepiece 1A, the crystal 112 is first fit into the bezel 111 of the retainer ring 110 to assemble the retainer ring 110, and the glass cover 122 is fit into the back cover retaining ring 121 of the back cover 120 to assemble the back cover 120. The bezel-side packing member 114 is then fit into the bezel-side retainer channel 111F of the retainer ring 110, and the back-cover-side packing member 124 is fit into the back-cover-side retainer channel 121G of the back cover 120. The first glass retaining packing member 134 and the second glass retaining packing member 135 are also respectively fit into the first glass retaining channel 131E and the second glass retaining channel 1311 of the metal part 131 of the case body 130.

The movement 210, to which the hands 170 and dial 140 have been attached, is then attached to the retainer ring 110.

The first glass part 132 is then mounted on the bezel-side retaining surface 111E of the retainer ring 110. The first glass part 132 is positioned by setting its inside surface against the bezel-side stop 111D at this time.

The metal part 131 is then placed on the first glass part 132. The metal part 131 is positioned at this time by setting the first glass stop 131C against the inside surface of the first glass part 132.

The second glass part 133 is then placed on the metal part 131. The second glass part 133 is positioned to the metal part 131 at this time by setting the inside surface of the second glass part 133 against the second glass stop 131G of the metal part 131.

The top (exposed edge) of the second glass part 133 is then covered by the back cover 120. The second glass part 133 and back cover 120 are positioned at this time by setting the back-cover-side stop 121E against the inside surface of the second glass part 133.

The set screws 150 are then passed through the screw holes 121H in the back cover 120, and screwed into the screw holes 111H in the back cover retaining flanges 111G of the retainer ring 110. Tightening the set screws 150 holds the case body 130 firmly between the retainer ring 110 and the back cover 120.

Because the first glass part 132 of the case body 130 is held between retainer ring 110 and the metal part 131 with the intervening bezel-side packing member 114 and first glass retaining packing member 134, the load on the first glass part 132 is absorbed by the elastic deformation of the packing members 114 and 134. Likewise, because the second glass part 133 of the case body 130 is held between the back cover 120 and the metal part 131 with the intervening back-cover-side packing member 124 and second glass retaining packing member 135, elastic deformation of the packing members 124 and 135 absorbs the load on the second glass part 133.

Effect of the Timepiece

As described above, the case body 130 of a timepiece 1A according to a preferred aspect of the invention has a substantially annular metal part 131, a first glass part 132 disposed between this metal part 131 and a retainer ring 110, and a second glass part 133 disposed between the metal part 131 and the back cover 120. A through-hole 131A for inserting the stem of a crown 160 is also formed in the metal part 131.

The inside of the timepiece 1A can therefore be seen from the side because the first glass part 132 and the second glass part 133 are made of glass. A timepiece 1A with a good appearance can also be achieved using the sense of high quality uniquely afforded by glass. Furthermore, because the through-hole 131A for passing the stem of the crown 160 is formed in the metal part 131, the durability of the first glass part 132 and second glass part 133 is not reduced, and a crown 160 can be passed through the case body 130.

Packing members 114, 134, 135, and 124 are respectively disposed between the retainer ring 110 and the first glass part 132, between the first glass part 132 and the metal part 131, between the second glass part 133 and the metal part 131, and between the second glass part 133 and the back cover 120.

Stress applied from the retainer ring 110 and metal part 131 on the first glass part 132, and stress from the back cover 120 and metal part 131 on the second glass part 133, can thus be better absorbed by the intervening packing members 114, 124, 134, and 135, thereby avoiding excessive stress on the first glass part 132 and second glass part 133, and preventing damage to the first glass part 132 and second glass part 133.

The bezel-side packing member 114, back-cover-side packing member 124, first glass retaining packing member 134, and second glass retaining packing member 135 are respectively disposed in a bezel-side retainer channel 111F, a back-cover-side retainer channel 121G, a first glass retaining channel 131E, and a second glass retaining channel 1311.

As a result, packing members 114, 124, 134, and 135 can be positioned without shifting radially between the retainer ring 110 and first glass part 132, between the first glass part 132 and the metal part 131, between the metal part 131 and the second glass part 133, and between the second glass part 133 and the back cover 120. A loss of strength caused by the packing members 114, 124, 134, and 135 shifting can thus be prevented, and a good appearance can be achieved.

The timepiece 1A according to a preferred embodiment of the invention uses packing members 114 and 124 as the shock absorbers. As a result, the water resistance of the timepiece 1A can be improved.

The metal part 131 also has a first glass stop 131C for positioning the first glass part 132, and a second glass stop 131G for positioning the second glass part 133. This prevents the first glass part 132, the metal part 131, and the second glass part 133 from shifting radially in position, and thereby maintains a good appearance and strength.

The outside case 100 is assembled with the case body 130 held between the back cover 120 and the retainer ring 110 by inserting set screws 150 from the screw holes 121H in the metal back cover 120 and screwing the set screws 150 into the screw holes 111H formed in the back cover retaining flanges 111G protruding from the metal bezel 111 of the retainer ring 110.

The strength of the timepiece 1A can thus be improved by threading screws into metal parts of the back cover 120 and retainer ring 110. Furthermore, because the first glass part 132 and the second glass part 133 are held between the retainer ring 110, back cover 120, and metal part 131 by means of the packing members 114, 124, 134, and 135, extreme stress applied axially by tightening the screws can be dispersed by the packing members 114, 124, 134, and 135.

The packing members 114, 124, 134, and 135 are formed with a substantially round section with a diameter substantially equal to the width of the matching bezel-side retainer channel 111F, back-cover-side retainer channel 121G, first glass retaining channel 131E, and second glass retaining channel 1311. As a result, when the packing members 114, 124, 134, and 135 are fit into the matching bezel-side retainer channel 111F, back-cover-side retainer channel 121G, first glass retaining channel 131E, and second glass retaining channel 1311, and the case body 130 is held between the retainer ring 110 and the back cover 120, elastic deformation of the packing members 114, 124, 134, and 135 in the radial direction is restricted by the side walls of the matching bezel-side retainer channel 111F, back-cover-side retainer channel 121G, first glass retaining channel 131E, and second glass retaining channel 1311, and the elastic strength of the packing members in the axial direction can be increased. The first glass part 132 and second glass part 133 are thus even better protected from applied stress, and damage thereto can be reliably prevented.

### Other Embodiments

The invention is not limited to the embodiments described above, and can be modified and improved in many ways without departing from the scope of the accompanying claims.

For example, in the foregoing first and second embodiments driving a stepping motor is controlled by a drive control circuit unit to display the time by means of the hands 170, but the invention is not so limited. For example, the radio-controlled timepiece could be a digital timepiece that has a liquid crystal display panel or other display area, and a drive control circuit unit that controls the LCD or other display to present the time.

In the first embodiment of the invention the antenna 200 is disposed substantially along the inside surface of the case body 130, but a bar antenna or antenna of some other shape can be disposed inside the outside case 100.

The case body 130 is made of glass in the first embodiment of the invention, but the case body 130 can be made of plastic or other non-magnetic material. The case body 130 is also not limited to transparent glass enabling viewing the inside of the radio-controlled timepiece 1 from the outside, and can be made of, for example, colored glass instead.

In the first and second embodiments of the invention the dial 140 and crown 160 are non-magnetic members, but can be made of a magnetic member such as metal. If the dial 140 is metal, the timepiece display can be imparted with a high quality appearance, and the design of the timepiece can be improved. If the dial 140 is made from a magnetic material, interference by the dial 140 with radio frequency reception can be reduced by positioning the antenna 200 near the glass cover 122 of the back cover 120. If the crown 160 is made from a magnetic material, interference with radio frequency reception can be reduced and good reception sensitivity can be achieved by positioning the antenna 200 away from the crown 160.

In the first embodiment of the invention a through-hole is formed in the back cover retaining ring 121 of the back cover 120 for inserting the stem of the crown 160, but the through-hole could be formed in the bezel 111 of the retainer ring 110 and the crown 160 could be inserted through the retainer ring 110.

In the first embodiment of the invention the case body 130 is held between the retainer ring 110 and the back cover 120 by intervening packing members 114 and 124, but the invention is not so limited. More specifically, stress is applied to the case body 130 from both the retainer ring 110 and the back cover 120 sides when the set screws are tightened in the first embodiment. However, the case body 130 could be bonded to the retainer ring 110 and the back cover 120 by adhesive, rendering a construction that prevents damage to the case body 130 by not applying stress to the case body 130. Replacing the battery and maintenance are enabled in this case by disposing the glass cover 122 of the back cover 120 removably from the back cover retaining ring 121. This also applies to the second embodiment. More specifically, the first glass part 132 and retainer ring 110, the second glass part 133 and back cover 120, the metal part 131 and first glass part 132, and the metal part 131 and second glass part 133 can be respectively bonded to each other using an adhesive.

In the first embodiment of the invention the packing members 114 and 124 are fit into the bezel-side retainer channel 111F and back-cover-side retainer channel 121G. Alternatively, annular channels could be formed in the surface of the retainer ring 110 facing the case body 130 and the surface of the back cover 120 facing the case body 130, and the packing members 114 and 124 can be fit into these grooves. It is also possible to omit the grooved channels in which these packing members 114 and 124 are fit. This also applies to the second embodiment, wherein grooves for holding the packing members 114, 124, 134, and 135 are omitted.

In the first and second embodiments of the invention the set screws 150 are inserted from the screw holes 121H in the back cover 120 and threaded into the screw holes 111H to hold the retainer ring 110 and back cover 120 together. However, any method of securing the retainer ring 110 and back cover 120 without interfering with standard time signal reception by the antenna 200 can be used, including bonding the retainer ring 110 and back cover 120 together with an adhesive as described above.

In the first embodiment of the invention packing members 114 and 124 are disposed as shock absorbers between the retainer ring 110 and case body 130 and between the back cover 120 and case body 130, but the invention is not so limited. The shock absorbing members can be rendered using a different type of elastic shock absorbing material, such as an elastic sponge material, so that stress applied to the case body 130 can be absorbed by the elastic shock absorbing member. The invention is also not limited to an annular shock absorbing member, and a plurality of shock absorbing members can be rendered with a specific interval therebetween at predetermined positions to the bezel-side retainer channel 111F and back-cover-side retainer channel 121G. As described above, stress applied to the case body 130 can also be absorbed by these shock absorbing members. Note, further, that by placing a water-resistant adhesive between the retainer ring 110 and the case body 130, and between the back cover 120 and the case body 130, in the two preceding examples, a drop in the water resistance can be prevented.

An elastic sponge member or other type of elastic shock absorbing member can likewise be used as the shock absorbing member in the foregoing second embodiment. The shock absorbing member is also not limited to a ring-shaped member, and a plurality of shock absorbing members can be rendered with a specific interval therebetween at predetermined positions to the bezel-side retainer channel 111F, the back-cover-side retainer channel 121G, the first glass retaining channel 131E, and the second glass retaining channel 1311. As described above, stress applied to the first glass part 132 and second glass part 133 can also be absorbed by these shock absorbing members. Note, further, that by placing a water-resistant adhesive between the retainer ring 110 and the first glass part 132, between the first glass part 132 and the metal part 131, between the second glass part 133 and the metal part 131, and between the second glass part 133 and the back cover 120, in this example, a drop in the water resistance can be prevented.

The case body 130 is entirely made of glass in the first embodiment described above, but the invention is not so limited. For example, both annular ends of the case body 130 could be made from a metal or other magnetic member sandwiching a glass ring member therebetween. This arrangement enables the standard time signal waves to pass freely through the glass part of the case body 130, and thereby improves the reception sensitivity of the antenna 200.

This also applies to the second embodiment. More specifically, the first glass part 132 and the second glass part 133 are described as being made entirely from glass, but the invention is not so limited. More specifically, a metal ring could be disposed to both annular ends of the glass ring members so that each glass ring member is sandwiched between the metal members.

In the first and second embodiments of the invention the back cover 120 is described having a substantially rectangular glass cover 122 disposed in a glass retaining hole 121A rendered in the back cover retaining ring 121, but the invention is not so limited.

For example, the glass cover 122 could be rendered as a circular arc over the antenna 200, or otherwise shaped suitably according to the shape of the antenna 200.

A standard time signal is used above by way of example as the received radio frequency signal (external radio information), but the invention is not so limited. For example, the received radio signals could be FM signals, GPS signals, radio frequencies that are used for cell phone communications, wireless data signals including Bluetooth and contactless IC cards, news broadcasts and weather reports, or other type of external wireless signal. It will be obvious that the design of the antenna 200 and the control circuit unit will vary according to the type of signals received. For example, if the received external wireless information is a weather report, an indicator can be driven by a stepping motor to point to an appropriate weather icon, such as sunny, cloudy, or rain. News, stock prices, and other information can also be displayed using a liquid crystal display or other type of digital display.

In the second embodiment of the invention the first glass part 132 and second glass part 133 are made of transparent glass so that the inside of the radio-controlled timepiece 1 can be seen. Alternatively, the first glass part 132 and second glass part 133 can be made from translucent glass colored a specific color, or opaque glass. If opaque glass is used the inside of the timepiece cannot be seen from the side of the timepiece, but the high quality appearance imparted by the glass can be used to give the timepiece a nice appearance.

It will also be obvious to one skilled in the related art that the specific construction and assembly methods of the embodiments described above can be varied in other ways without departing from the scope of the accompanying claims.

What is claimed is:

1. A timepiece comprising:
a retainer ring including a timepiece crystal and a glass retaining unit that holds the outside edge of the crystal;
a back cover that is disposed facing the retainer ring;
a case member that is substantially annular, is made at least in part from a non-magnetic member, and links the outside edges of the retainer ring and the back cover;
an antenna that is disposed in a space formed between the retainer ring and the back cover, and can receive radio signals that pass through the non-magnetic member of the case member to the inside of the case member; and
a timekeeping unit that is disposed in a space formed between the retainer ring and the back cover, and has a time display unit for displaying the time.

2. The timepiece described in claim 1, wherein:
the non-magnetic member of the case member is formed in a ring around the circumference of the case member.

3. The timepiece described in claim 1, wherein:
the case member is made from glass, which is a non-magnetic member.

4. The timepiece described in claim 1, wherein:
the back cover includes a flat non-magnetic member, and a retainer part that holds the outside edge of the non-magnetic member.

5. The timepiece described in claim 1, wherein:
the time display unit of the timekeeping unit has hands and a dial; and
the dial is a non-magnetic member.

6. The timepiece described in claim 1, further comprising:
an operating unit for operating the timekeeping unit; and
a through-hole formed in the glass retaining unit of the retainer ring or the back cover for inserting the stem of the operating unit.

7. The timepiece described in claim 6, wherein:
the operating unit is a non-magnetic member.

8. A timepiece comprising:
a retainer ring including a timepiece crystal and a glass retaining unit that holds the outside edge of the crystal;
a back cover that is disposed facing the retainer ring;
a substantially annular case member that is held between the retainer ring and the back cover;
a timekeeping unit that is disposed in the space enclosed between the retainer ring, the back cover, and the case member, and has a time display unit for displaying the time; and
an operating unit that is connected to the timekeeping unit and enables controlling the operating content of the timekeeping unit;
wherein the case member has
a metal part that is formed substantially in a ring from a metal material and has a through-hole for inserting the stem of the operating unit,
a substantially annular first glass part that is made from glass at least in part and is disposed between the metal part and the retainer ring, and
a substantially annular second glass part that is made from glass at least in part and is disposed between the metal part and the back cover.

9. The timepiece described in claim 8, wherein:
a shock absorbing member is disposed between the first glass part and the retainer ring, between the first glass part and the metal part, between the second glass part and the metal part, and between the second glass part and the back cover.

10. The timepiece described in claim 9, wherein:
a substantially annular channel is formed following the edge of the case member on the surface of the retainer ring facing the first glass part, the surface of the back cover facing the second glass part, the face of the metal part facing the first glass part, and the face of the metal part facing the second glass part; and
the shock absorbing members are disposed in said annular channels.

11. The timepiece described in claim 9, wherein:
the shock absorbing member is a substantially annular packing member that seals between the first glass part and the retainer ring, between the first glass part and the metal part, between the second glass part and the metal part, and between the second glass part and the back cover.

12. The timepiece described in claim 8, wherein:
the metal part has an engaging part that engages the first glass part and the second glass part, and positions the first glass part and the second glass part coaxially to the metal part.

13. The timepiece described in claim 8, wherein:
the glass retaining part of the retainer ring has a back cover locking part that projects toward the back cover, and
the protruding distal end of the back cover locking part contacts the back cover and has a screw screwed therein through the back cover; and
the case member is held between the glass retaining part of the retainer ring and the back cover with an intervening shock absorbing member.
